(19) United States
(12) Patent Application Publication
(10) Pub. No.: US 2015/0232367 A1
(43) Pub. Date: Aug. 20, 2015

(54) PRESS BENDING MOLD CLOTH CHANGE SYSTEM AND METHOD

(71) Applicant: CORNING INCORPORATED, Corning, NY (US)

(72) Inventors: Laurent Joubaud, Paris (FR); Stephane Poissy, Brunoy (FR)

(21) Appl. No.: 14/623,667

(22) Filed: Feb. 17, 2015

Related U.S. Application Data
(60) Provisional application No. 61/941,263, filed on Feb. 18, 2014.

(51) Int. Cl. C03B 23/03; C03B 35/14; C03B 40/00

(52) U.S. Cl. CPC C03B 23/0302; C03B 40/005; C03B 35/14

(57) ABSTRACT

A bending apparatus or lehr for bending a structure, the bending apparatus having a movable shaping mold with a mold cloth disposed about portions of the movable shaping mold. The mold cloth can be replaced without reducing temperature in the bending apparatus or lehr and during normal operation of the bending apparatus or lehr.

### CROSS-REFERENCE TO RELATED APPLICATIONS

This application claims the benefit of priority under 35 U.S.C. §119 of U.S. Provisional Application Ser. No. 61/941,263, filed on Feb. 18, 2014, the content of which is relied upon and incorporated herein by reference in its entirety.

### BACKGROUND

Lehrs for annealing and tempering of glass structures are generally known. For example, U.S. Pat. No. 4,481,025 describes a conventional lehr for heat treating glass structures whereby the lehr is comprised of a series of modules which define an elongated insulated tunnel. A belt conveyor extends through the tunnel for moving glass structures from one end to the other. Duct work connections between the tunnel and ambient air, along with heaters and blowers can establish heating, tempering, and cooling zones within the lehr in the direction of conveyor movement.

Such conventional lehrs, however, cannot provide controlled heating and cooling of thin glass structures and glass laminate structures to prevent wrinkling thereof. Further, such conventional lehrs do not provide in situ bending or forming of thin glass structures.

### SUMMARY

Some embodiments of the present disclosure provide a bending apparatus for bending a substrate, the bending apparatus having a movable shaping mold with a mold cloth disposed about portions of the movable shaping mold. An exemplary bending apparatus can include a system for replacing the mold cloth without reducing temperature in the bending apparatus.

In other embodiments, a lehr is provided having a heating zone with a plurality of heating modules aligned and connected to each other to define a first tunnel wherein adjacent heating modules are separated from each other by a furnace door, a bending zone subsequent the heating zone with at least one bending module defining a second tunnel wherein the at least one bending module is separated from modules in adjacent zones by a furnace door, a cooling zone subsequent the bending zone and having a plurality of cooling modules aligned and connected to each other to define a third tunnel wherein adjacent bending modules are separated from each other by a furnace door, and a conveyance mechanism for carrying one or more structures in a first direction through the heating, bending and cooling modules via the first, second and third tunnels, wherein the bending module includes a movable shaping mold with a mold cloth disposed about portions of the movable shaping mold. This lehr can include a mechanism for replacing the mold cloth without opening the bending module in a direction perpendicular to the first direction.

In further embodiments, a lehr is provided having a heating zone with a plurality of heating modules aligned and connected to each other to define a first tunnel wherein adjacent heating modules are separated from each other by a furnace door, a bending zone subsequent the heating zone with at least one bending module defining a second tunnel wherein the at least one bending module is separated from modules in adjacent zones by a furnace door, a cooling zone subsequent the bending zone and having a plurality of cooling modules aligned and connected to each other to define a third tunnel wherein adjacent bending modules are separated from each other by a furnace door, and a conveyance mechanism for carrying one or more structures in a first direction through the heating, bending and cooling modules via the first, second and third tunnels, wherein the bending module includes a movable shaping mold with a mold cloth disposed about portions of the movable shaping mold. This lehr can include mechanisms for replacing the mold cloth without reducing temperature in the bending module.

Additional features and advantages of the claimed subject matter will be set forth in the detailed description which follows, and in part will be readily apparent to those skilled in the art from that description or recognized by practicing the claimed subject matter as described herein, including the detailed description which follows, the claims, as well as the appended drawings.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIG. 1 is a series of deformation plots of bent glass structures showing modeled stresses in MPa.

FIG. 2 is another deformation plot of a bent glass structure showing modeled stresses in MPa.

FIG. 3 is a simplified illustration of an exemplary lehr according to some embodiments of the present disclosure.

FIGS. 4A and 4B are illustrations of exemplary heating elements according to some embodiments of the present disclosure.

FIG. 5 is a simplified diagram of a press-assist module according to some embodiments of the present disclosure.

FIG. 6 is a graphical side depiction of one embodiment of an exemplary pressing system.

FIG. 7 is an exploded view of some embodiments of the present disclosure.

FIGS. 8A-8B graphically illustrate some embodiments of an exemplary bending mold quick cloth exchange system.

FIGS. 9A-9K graphically illustrate a pressing cycle with a mold cloth exchange.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified.

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations of the present disclosure are possible and may even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the following description of exemplary or illustrative embodiments is provided for the purpose of illustrating the principles of the present disclosure and not in limitation thereof and may include modification thereto and permutations thereof.

Some embodiments of the present disclosure include a press bending process and system for the generation of complex shapes in a glass substrate or in glass laminate structures. In contrast to conventional standard sagging processes, exemplary systems and machines described herein can include a ring were the substrate can be seated and heated whereby a suspended mold can be utilized to press the glass into a desired shape. Conventionally, pressing force was defined by a mold weight which was dropped on the glass sheet and an adjacent ring; however, when too much force was applied, the substrate was press marked resulting in low quality bent glass products. Exemplary embodiments can thus include a counterbalance system to adjust the pressing force and spread the compensated force more uniformly and to limit mold press marks on the glass parts. Such systems can also be employed for bending soda lime glass down to thicknesses of 2.1 mm. Bending thin glass having thicknesses below 2.1 mm or thicknesses between 0.3 mm and 1.5 mm, however, is difficult as thin glass does not bend in the same manner as thicker (2.1 mm and above) glass. Embodiments of the present disclosure can be utilized to bend both thick glasses (thicknesses greater than about 2.1 mm) and thin glasses, as well as multiple sheets of thin and/or thick glasses and/or laminate (e.g., glass-glass laminates, glass-polymer laminates) structures.

Glass covers for devices with electronic displays or touch controls are increasingly being formed of thin glass that has been chemically strengthened using an ion exchange process, such as Gorilla® Glass from Corning Incorporated. Automotive applications, e.g., windshields, side windows or lites, rear windows, sunroofs, etc., are also being formed of thin glass to meet emissions requirements. Such chemically strengthened glass can provide a thin, lightweight glass structure with an enhanced fracture and scratch resistance, as well as an enhanced optical performance. Ion exchangeable glasses typically have a relatively higher CTE than non-ion exchangeable glasses. Ion exchangeable glasses may, for example, have a high CTE in the order of 70×10⁻⁷ C⁻¹ to 90×10⁻⁷ C⁻¹. Exemplary thin glass sheets according to embodiments of the present disclosure can have a thickness of up to about 2.1 mm, up to about 1.5 mm or 1.6 mm, up to about 1 mm, up to about 0.7 mm, or in a range of from about 0.5 mm to about 1.5 mm, or from about 0.5 mm to about 0.7, or from 0.3 mm to about 0.7 mm.

Assembly tolerances in the order of +/−0.5 mm or less are often required to provide the desired quality look, feel, fit and finish for a specific application. Such tolerances are difficult to achieve when performing high temperature, localized, high precision bending of relatively high CTE or relatively large glass sheets or structures, e.g., a laminate structure having a dimension of over 1 m², of ion exchangeable glass. When heating a relatively large glass sheet(s) or a relatively high CTE glass sheet(s) to a temperature that softens the glass so that it can be bent or formed to the desired shape, the sheet(s) of glass can expand by as much as 10 mm in one or more directions. This expansion of the glass creates challenges in maintaining high precision tolerances when heating and bending the glass sheet. After bending the ion exchangeable glass to the correct shape, the glass can be ion exchanged to provide the desired chemical strengthening or tempering of the glass sheet.

The present disclosure provides a solution for precision shaping of large glass sheets, in particular relatively large sheets of relatively high CTE glass, using a localized high temperature bending processes, and more particularly thin, relatively high CTE sheets. The term “thin” as used herein means a thickness of up to about 2.1 mm, up to about 1.5 mm or 1.6 mm, up to about 1.0 mm, up to about 0.7 mm, or in a range of from about 0.5 mm to about 1.0 mm, or from about 0.5 mm to about 0.7 mm or from about 0.3 mm to about 0.7 mm. The terms “sheet”, “structure”, “glass structures”, “laminate structures” may be used interchangeably in the present disclosure and such use should not limit the scope of the claims appended herewith.

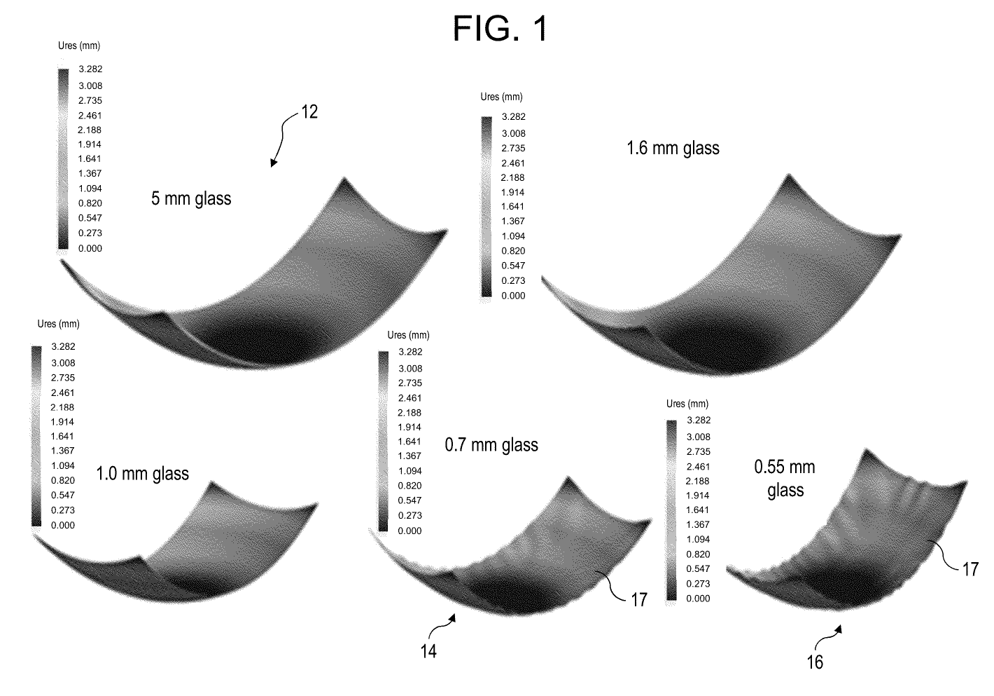

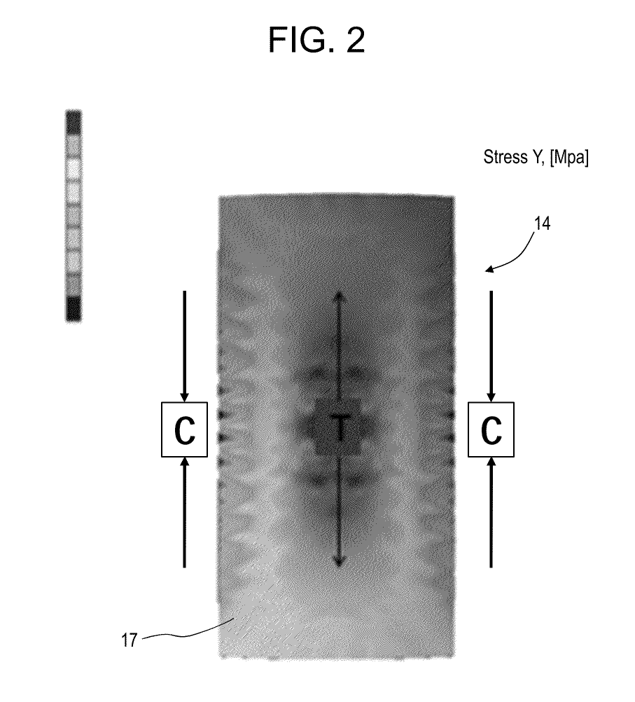

Applicant has discovered that bending thin glass is significantly different than bending conventional thicknesses of glass. FIG. 1 is a series of deformation plots of bent glass structures showing modeled stresses in MPa. As shown in FIG. 1, the interior portions of the illustrated bent glass structures exhibit tension whereas the exterior portions thereof exhibit compressive stress. Thicker glass structures, such a 5 mm thick glass structure or laminate 12, do not exhibit unacceptable wrinkling; however, such is not the case with thin glass structures such as 0.7 mm thick glass structures or laminates 14 and 0.55 mm thick glass structures or laminates 16 which exhibit this unacceptable wrinkling Applicant has discovered that this wrinkling 17 is due, in part, to the bending process of these glass structures which creates a strong membrane tension in the glass center with large compressive hoop stresses near the edges. The balancing of these tension and compressive stresses result in edge wrinkling in thin glass structures and laminates as exhibited in FIG. 2. It has also been discovered that the degree of curvature of the glass or laminate structure (i.e., the complexity of the bent shape) adds to the degree of wrinkling thereof.

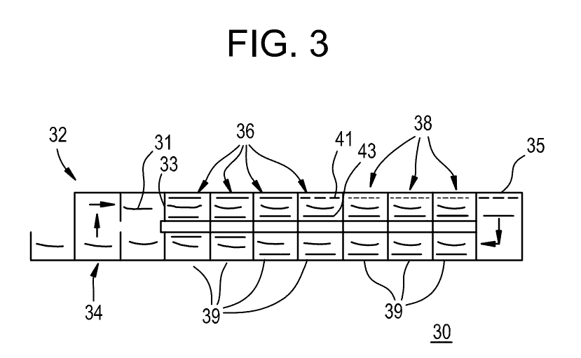

FIG. 3 is a simplified illustration of an exemplary lehr according to some embodiments of the present disclosure. With reference to FIG. 3, an exemplary lehr 30 can include a plurality of “wagons” or modules 32. In one embodiment, the lehr 30 can include eighteen modules 32. Of course, exemplary lehrs 30 can include more or less than eighteen modules 32 depending upon the size and/or thickness of a respective part or structure to be bent, the number of molds for the structure(s), and the number of glass parts or structures per mold. Adjacent modules can be separated from each other by blast or furnace doors 33 or other suitable mechanisms. The lehr 30 can include a suitable feeding mechanism to feed one or more sheets of glass or a laminate structure 31 into a loading lift module 34 whereby the structure 31 is conveyed into successive modules by a conveyance mechanism. Exemplary glass and laminate structures 31 include, but are not limited to, a glass sheet, multiple glass sheets in a single stack, a glass-glass laminate structure, and a glass-polymer laminate structure, to name a few. Exemplary conveyance mechanisms include, but are not limited to, transfer rolls, conveyance carriages, and other suitable carts or carriages in the industry. In some embodiments, a conveyance mechanism can include suitable substrate or sheet registration mechanisms such as, but not limited to, the registration mechanisms described in pending U.S. application Ser. No. 13/303,685, the entirety of which is incorporated herein by reference. In one embodiment, the glass or laminate structure 31 can be conveyed from the loading lift module 34 into one or more preheating or heating modules 36. In the embodiment depicted in FIG. 3, a series of four or more heating modules 36 can be provided to advance or increase the temperature of the glass or laminate structure 31 to a desired temperature or to meet a desired temperature profile. Of course, any number of heating modules 36 are envisioned in embodiments of the present disclosure and such a depiction should not so limit the scope of the claims appended herewith.

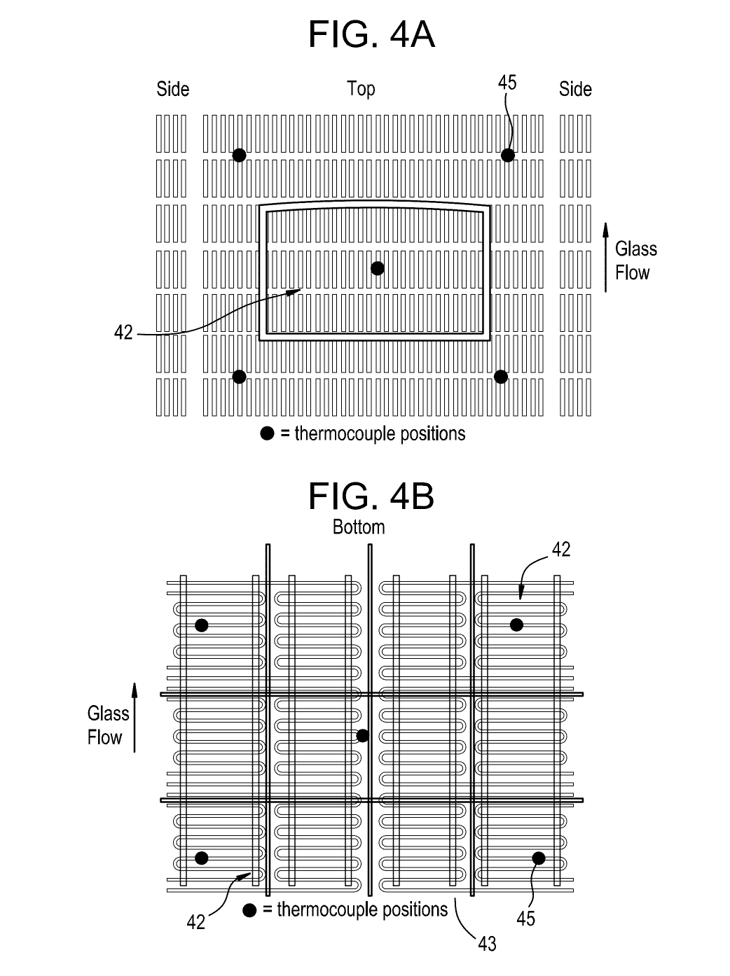

FIGS. 4A and 4B are illustrations of exemplary heating elements according to some embodiments of the present disclosure. With reference to FIGS. 4A and 4B and with continued reference to FIG. 3, any one or several of the modules 32 in an exemplary lehr 30 can include a top set of heating elements 41 and/or a bottom set of heating elements 43 in a respective module 32. These heating elements 41, 43 can be arranged to form heating and/or cooling zones 42 any of which can be independently controllable. Of course, the number of zones depicted in FIGS. 4A and 4B is exemplary only and should not limit the scope of the claims appended herewith as additional heating/cooling zones can be provided in any of the modules 32. Exemplary heating elements can be, but are not limited to, electrically conductive ceramic materials (e.g., silicon carbide, disilicide molybdenum, titanium diboride, etc.) generally shaped as straight or curved tubes which can be employed to dissipate power via heat radiation into a furnace environment, e.g., a module 32 of an exemplary lehr. In one embodiment, exemplary heating elements can be those described in U.S. application Ser. No. 13/302,586, the entirety of which is incorporated herein by reference.

While not shown in FIG. 3, each set of heating elements 41, 43 can include a plurality of thermocouples and/or pyrometers 45 provided at predetermined positions in the module to allow proper monitoring and control of each element or set of elements or zones. The thermocouples/pyrometers 45 are adaptable to send signals to the control system to regulate the exact temperature control within a respective module 32 through the starting and stopping of any individual or set(s) of heating elements 41, 43 in a respective module 32 thereby controlling the heating and cooling of a glass sheet(s) or laminate structure in a respective module 32. In another embodiment of the present disclosure, shielding material (not shown) such as, but not limited to, aluminosilicate refractory fibers or another suitable insulative material, can be utilized to assist in the heating and cooling of a respective glass sheet(s) or laminate structure within a module(s) 32. For example, it was discovered that many complex bent, thin glass part shapes for automotive or other applications required a level of differential heating that cannot be fully achieved with furnace heating control alone. Thus, in such cases, a combination of differential heating element control with appropriate shielding materials/panels (dynamic or static) can be employed. Exemplary static shielding can be employed directly on a respective glass sheet or laminate structure or can be a function of the carrying mold or conveyance mechanism. Exemplary dynamic shielding can be employed and controlled utilizing an exemplary movable shielding mechanism within a respective module 32 that is controlled using an exemplary control system. After an exemplary glass or laminate structure 31 has been elevated to a desired temperature, the glass or laminate structure 31 can be conveyed from the series of heating modules 36 to one or more bending modules 38 whereby the glass or laminate structure 31 can be bent to a desired shape. Exemplary bending or pressing modules 38 can also include top and bottom heating elements 41, 43 to maintain and/or control the temperature of the glass or laminate structure 31 contained within the respective bending module 38 as will be described later.

Upon obtaining a desired shape, the glass or laminate structure 31 can then be provided to an additional lift module 35 whereby the glass or laminate structure 31 is conveyed to one or more successive cooling modules 39. The additional lift module 35 can include top and bottom heating elements 41, 43 and respective thermocouples/pyrometers 45 to maintain and/or control the temperature of the bent glass or laminate structure 31 contained therein. Exemplary cooling modules 39 can also include top and/or bottom heating elements 41, 43 and respective thermocouples/pyrometers 45 to provide a controlled cooling of the temperature of the bent glass or laminate structure 31 contained therein. It should be noted that the exact temperature control within any of the lift module 35 and cooling modules 39 can, like the heating modules 36, bending modules 38, etc., be regulated through the starting and stopping of any individual or set(s) of heating elements 41, 43 in a respective module to thereby control the heating and cooling of a bent glass sheet or laminate structure in a respective module. In another embodiment of the present disclosure, shielding (not shown) can be utilized to assist in the heating and cooling of a respective glass sheet(s) or laminate structure within the module(s). Upon being cooled to a predetermined temperature, the bent glass or laminate structure 31 can then exit the series of cooling modules 39 into the loading module 34. While the embodiment depicted in FIG. 3 is illustrated as a stacked lehr embodiment (e.g., heating features and cooling features stacked upon each other along with lift modules), the claims appended herewith should not be so limited as an exemplary lehr can be substantially linear in form, that is, an exemplary glass or laminate structure to be bent is not conveyed vertically by a lift module but is only conveyed horizontally along a series of heating, bending and cooling modules. Additional lehr and heating embodiments are described in U.S. Application No. 61/846,692 filed Jul. 16, 2013 and entitled, “System and Method for Bending Thin Glass,” the entirety of which is incorporated herein by reference.

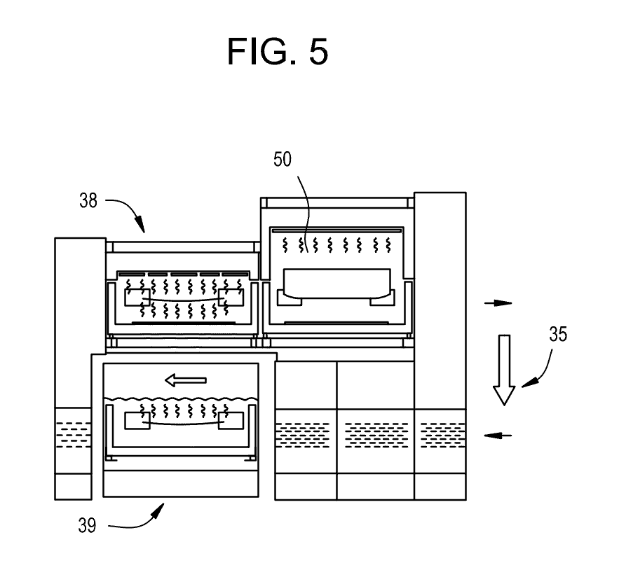

With continued reference to FIG. 3, to locally bend or form a thin glass sheet(s) or laminate structure into a desired shape, the glass sheet(s) or structure can be supported on a frame or mold in an exemplary bending or pressing module 38. The glass sheet or laminate structure (e.g., one glass sheet, multiple glass sheets in a stack, a glass-glass laminate structure, a glass-polymer laminate structure, etc.) can then be allowed to sag, e.g., deform to the shape of the mold under its own weight while the structure is held in an appropriate temperature range. In another embodiment, a force or press-assist mechanism 50 as illustrated in FIG. 5 can be applied to the glass or laminate structure to aid in the deformation thereof and/or to assist deformation of the structure to difficult shapes and bend tolerances, e.g., automotive windshields, sunroofs and other applications. Further, embodiments of the present disclosure can further provide a full surface mold press for varying depth shapes (e.g., 10 mm to 25 mm shapes) to develop deep complex curvatures that cannot conventionally be generated with localized temperature gradients. An exemplary press-assist module or mechanism 50 can also include a continuously varying ram speed (e.g., approaching 0.01 mm/sec or more) to assist in shaping such complex curvatures. Such an exemplary press-assist mechanism 50 or module can be provided between one bending module 38 and an exemplary lift module, and the capacity of an exemplary lehr 30 can be a function of the size of a respective part or structure, number of molds and/or modules, and the number of glass panes or structures per mold.

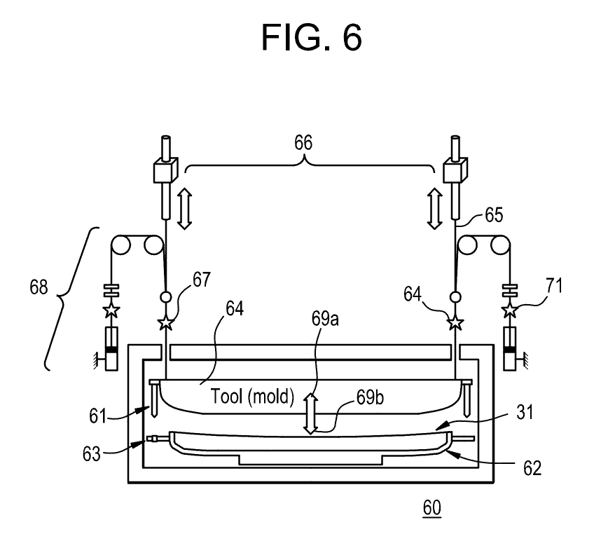

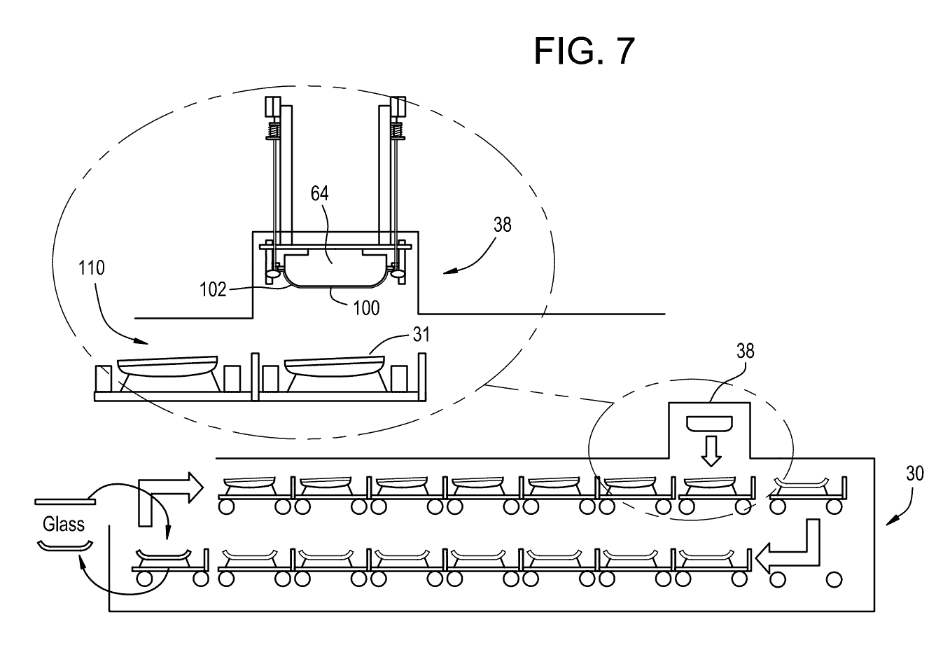

With continued reference to FIGS. 3 and 5, in some embodiments exemplary bending modules 38 can include a tunable mold system integrated therein. In other embodiments, a tunable mold system can be integrated into a press assist module provided between bending modules 38 and the lift module 35 in a press-assist module 50. FIG. 6 is a graphical side depiction of one embodiment of an exemplary pressing system. FIG. 7 is a perspective view of the mold and overhead mechanism of FIG. 6. With reference to FIGS. 6 and 7, an exemplary pressing module or system 60 is illustrated having a glass or laminate structure 31 seated onto a ring or ring mechanism 62. The glass or laminate structure 31 can be maintained at a predetermined temperature, e.g., 600° C., 650° C., 700° C., 750° C., etc. or can be heated up to such an exemplary temperature in the pressing module 60 using a temperature profile as described in U.S. Application No. 61/846,692 filed Jul. 16, 2013 the entirety of which is incorporated herein by reference. One or more molds 64 can be pressed against the glass or laminate structure 31 to form a desired glass or laminate shape. In some embodiments, the mold 64 can be aligned with the ring or ring mechanism 62 utilizing one or more alignment pins 61 fixedly attached to the mold 64. These alignment pins 61 can mate with corresponding alignment interfaces 63 on the ring mechanism 62. In some embodiments, a plurality of alignment pins 61 can be provided where one or more alignment pins 61 set a location for the mold 64 with respect to the ring mechanism 62 and another alignment pin(s) 61 define an orientation of the mold 64 with respect to the ring mechanism 62. While not shown, rolls can also be utilized to minimize friction between moving parts in the pressing module 60. Control and movement of the mold 64 can be provided utilizing an exemplary overhead mechanism 66. In some embodiments, the mold 64 can be suspended with cables, lifting screws, guide rods, chains 65 or another suitable mechanism. An exemplary counterweight system 68 may also allow an operator to set a fully adjustable counterweight force on each corner or portion of a respective mold 64. In some embodiments, this adjustable counterweight force can be programmable along the entire stroke of the mold or portions thereof from a first suspended position 69a through and to a second position 69b interfacing with or contacting the glass or laminate structure 31. It should be noted that while one mold and ring have been depicted and described, the claims appended herewith should not be so limited as embodiments can include a single mold and multiple rings, multiple molds and multiple rings, etc. Additional exemplary press bending modules are described in co-pending U.S. Application No. [[SP14-035]] filed Feb. 18, 2014, entitled, “Tunable Mold System for Glass Press Bending Equipment,” the entirety of which is incorporated herein by reference.

FIG. 7 is an exploded view of some embodiments according to the present disclosure. With reference to FIG. 7, an exemplary pressing or bending module 38 is illustrated without partitions (for ease of reference) and showing successive wagons in the heating, cooling and lifting modules of an exemplary lehr 30. An exemplary mold 64 can include a fabric or other material 100 on a surface 102 thereof proximate the glass or laminate structure 31 which is to be bent or pressed into a desired shape. It should be noted that while the lehrs described herein have referenced wagons 110 or modules, the claims appended herewith should not be so limited as exemplary lehrs can include roller mechanisms as well. In some embodiments, a high temperature material 100 can be used on the surface 102 to spread a pressing force over the structure 31 during the pressing thereof. For example, this material can be, but is not limited to, a stainless steel fabric, a high temperature carbon fiber mesh or fabric, a fabric mesh reinforced with fireproofing products or materials, ceramic cloth, aluminized fiberglass cloth, vermiculite treated fiberglass cloth, ceramic paper, ceramic insulation, silica cloth, aramid fiberglass cloth, and other suitable high temperature meshes or fabrics. Such meshes or fabrics can enable a soft touch of a mold against a substrate and can reduce or eliminate generation of optical defects on the pressed glass or laminate surface. Of course, the mesh or fabric, however, can wear with time and should be exchanged. Additionally embodiments of the present disclosure can be utilized with colder bending temperatures than those specified herein, thus, some exemplary mesh materials listed above may be applicable to certain higher temperature ranges whereas other mesh materials may be applicable to lower temperature ranges. Conventionally, exchange of the material 100 requires several hours of downtime for the lehr due to cool down of the lehr or portions thereof, cloth exchange and then subsequent heat up of the lehr or portions thereof. This downtime can lead to significant production loss.

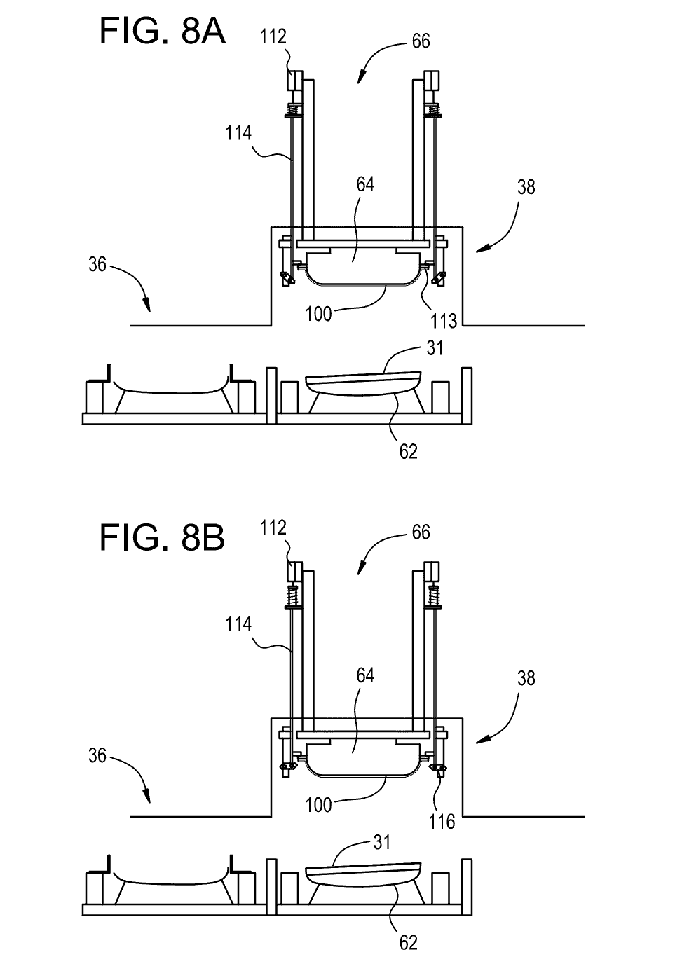

Thus, some embodiments provide a system and method for enabling a quick change of the mesh or fabric material 100 on the mold 64 without disturbing the mold, module, wagon or lehr thermal profile and hence reducing process instabilities. In some embodiments, the material 100 can replicate the geometry of the respective mold 64, and thus, pressed glass or laminate shape can be a function of mold geometry and material thickness. Thus, the mesh material 100 can be a non-uniform mesh or a uniform mesh having a substantially uniform thickness. Additionally, exemplary mesh material 100 can include integrated metal shims (not shown) as necessary. In the event that the material 100 needs to be exchanged, instead of conventionally removing the mold 64 out of and off the lehr 30 to exchange the material 100 or even opening the bending module 38 to exchange the material 100, some exemplary embodiments can utilize the movement of the wagons 110 or rollers within the lehr to unload a cloth frame on one wagon and load a new cloth on a subsequent wagon. FIGS. 8A-8B graphically illustrate some embodiments of a bending mold quick cloth exchange system. With reference to FIG. 8A, a detailed view of a press bending module 38 and preceding module 36 are illustrated with a ring mechanism 62 loaded with a glass or laminate structure 31. With continued reference to FIG. 8A, an exemplary overhead mechanism 66 can include a mold cloth release actuator 112 or other suitable mechanical, electrical, pneumatic or hyrdraulic mechanism that when actuated (locally, manually, remotely, etc.), contacts a guide device or rod 114 which can move portions of a mold cloth frame 113, in one embodiment, that holds the mold cloth material 100 to the mold 64. FIG. 8A illustrates the actuator 112 in an energized or actuated state. When the actuator 112 is in an non-energized or actuated state, the guide device or rod 114 can be in tension or moved vertically upward by spring, hydraulic, pneumatic force thereby engaging the mold cloth frame 113 to the mold 64, or in the embodiment shown in FIG. 8B, rotating frame latches 116 to mate the mold cloth frame 113 to the mold 64.

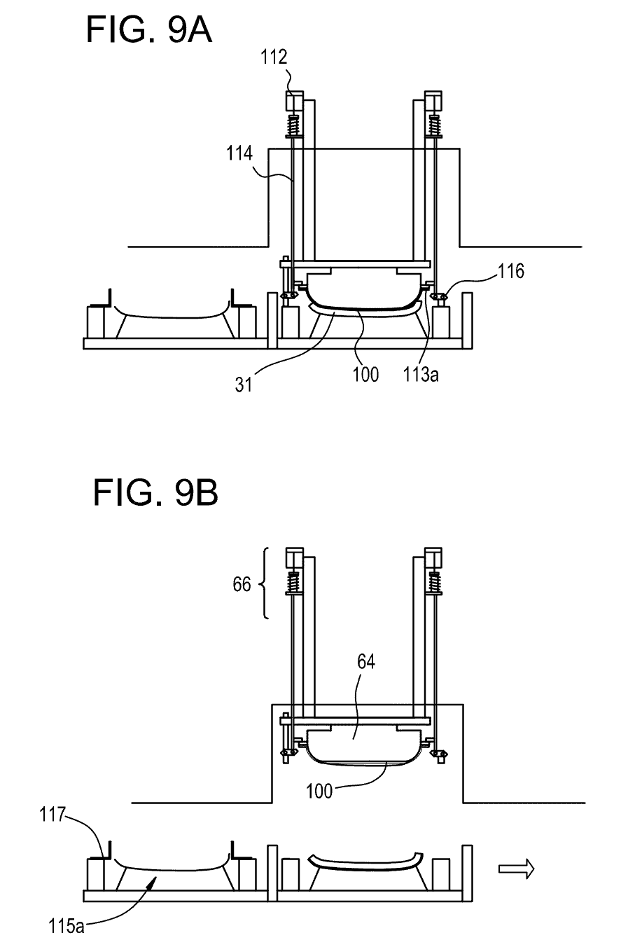

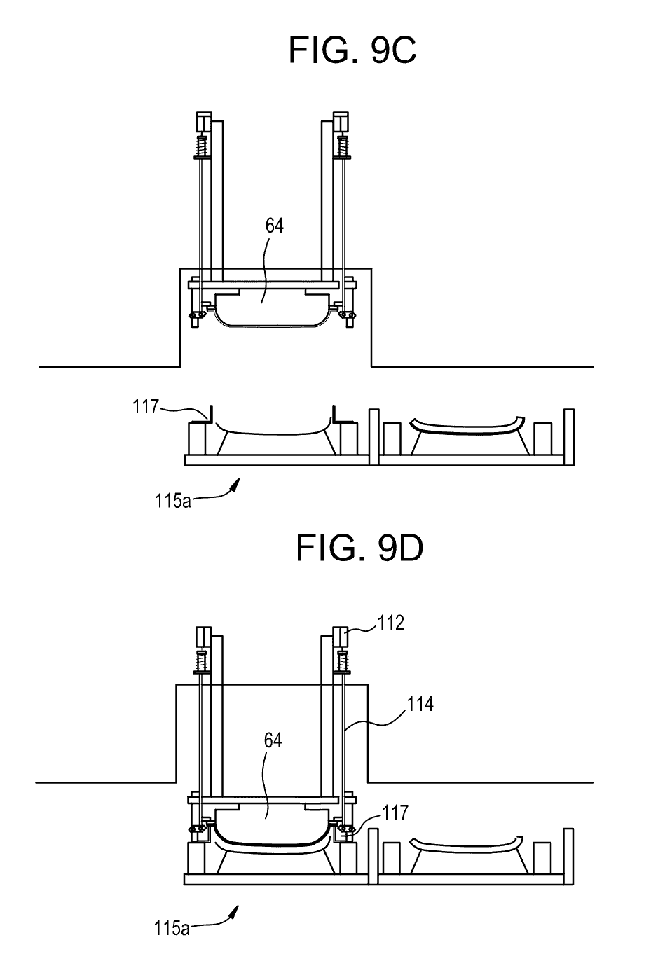

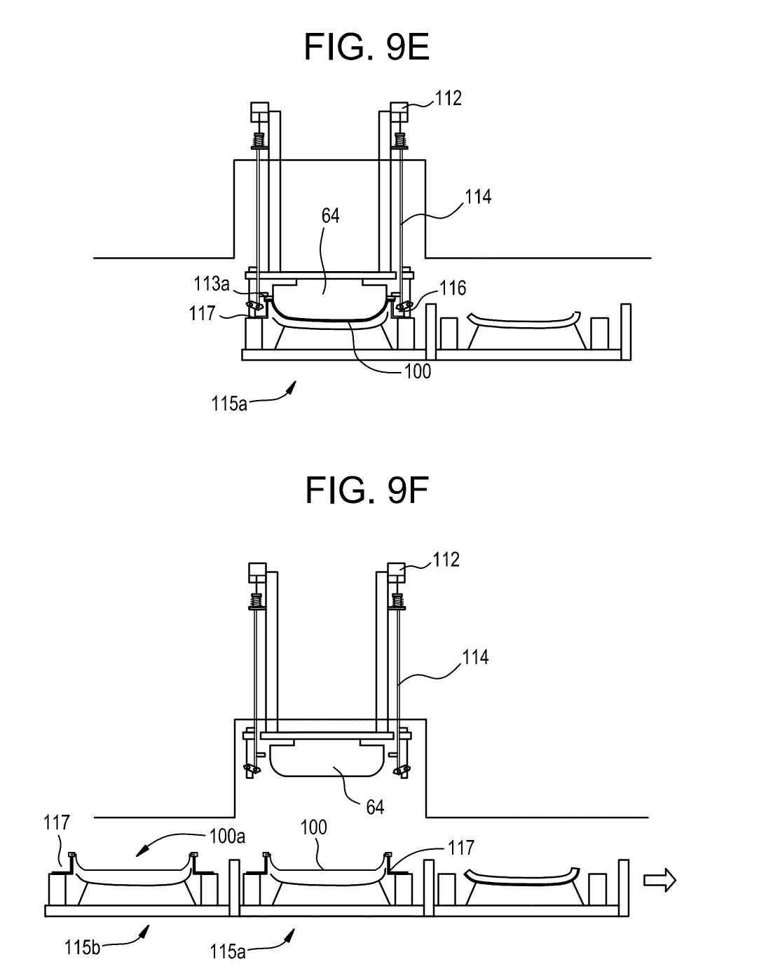

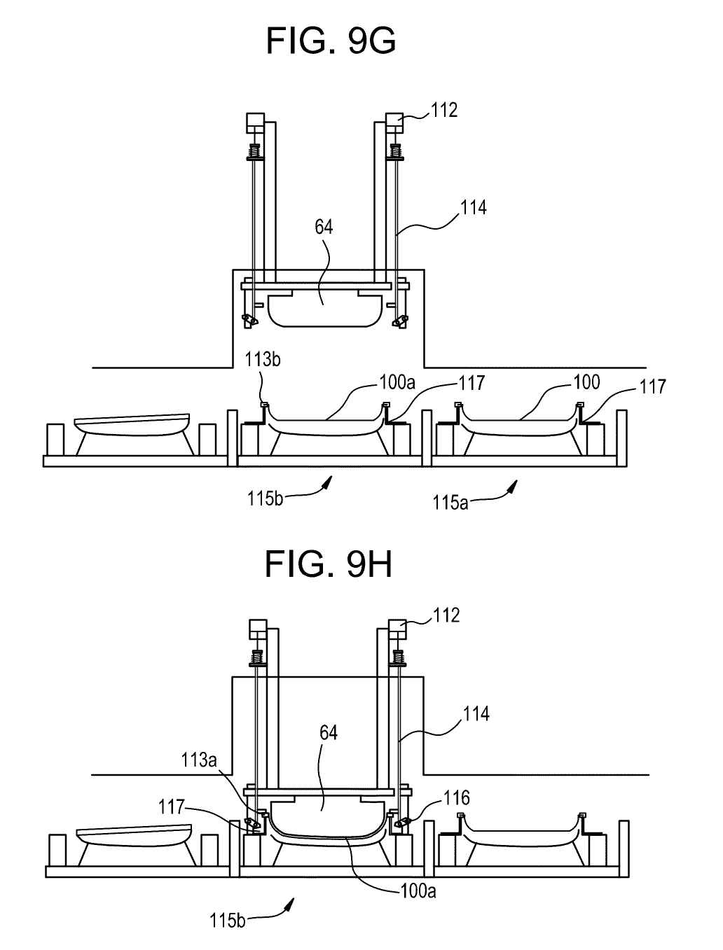

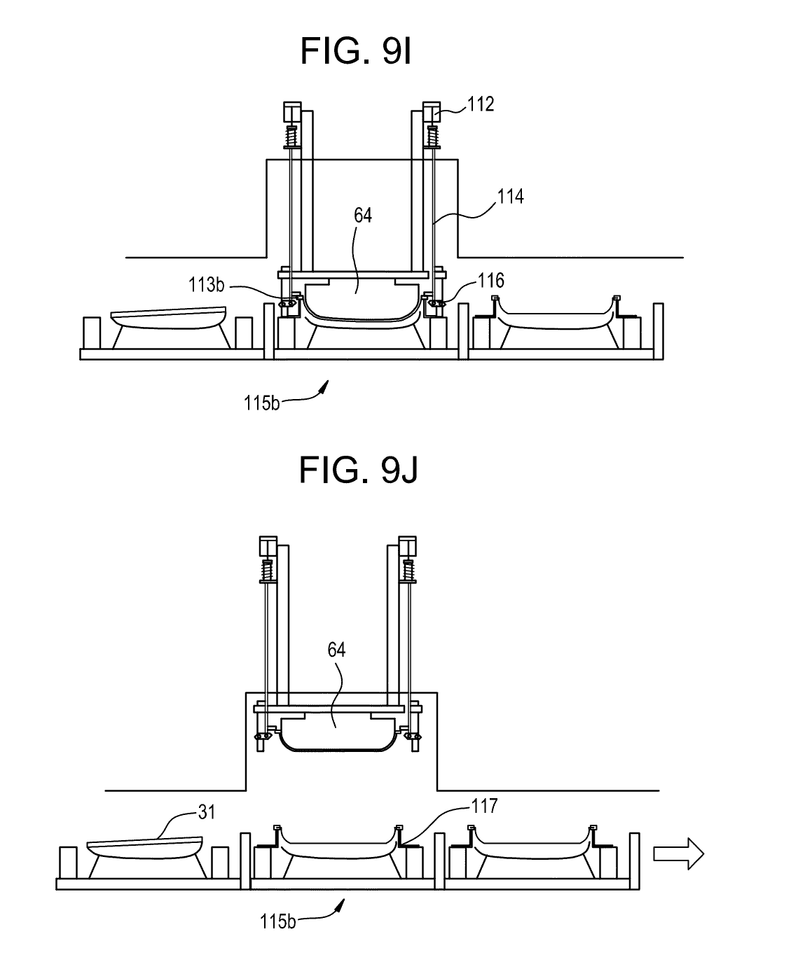

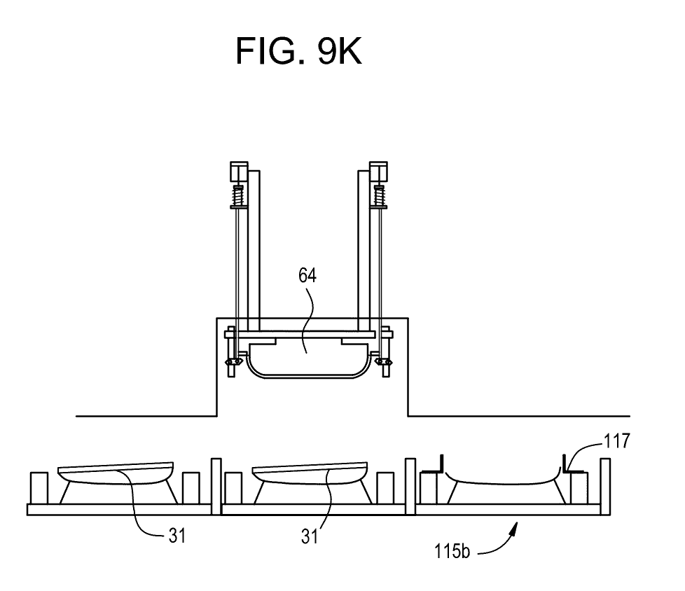

FIGS. 9A-9J graphically illustrate a pressing cycle with a mold cloth exchange. With reference to FIG. 9A, the mold 64 is illustrated in a pressing position whereby the actuator 112 is in a non-energized or actuated state and the guide device or rod 114 is fully extended thereby allowing the rotating frame latches 116 to mate with the mold cloth frame 113a. In this manner, the mold 64 along with the mold cloth material 100 can be used to press or bend an exemplary glass or laminate structure 31. As illustrated in FIG. 9B, the wagons can be moved laterally and the mold 64 raised by an exemplary overhead mechanism 66. In the event that the mold cloth material 100 needs to be exchanged, a first wagon 115a can be loaded with a mold cloth frame support 117 (in the place of a glass sheet or laminate structure) during loading at the entrance of the lehr 30. Thus, during normal processing, the first wagon 115a can be indexed into place under the mold 64 as illustrated in FIG. 9C. The mold 64 is then moved vertically and pressed into the first wagon 115a and mold cloth frame support 117 as illustrated in FIG. 9D. Once in a pressed position, the mold cloth release actuator 112 or other suitable mechanical, pneumatic or hyrdraulic mechanism is actuated which contacts the guide device or rod 114 and which can move portions of the mold cloth frame 113a, in one embodiment, or in another embodiment, rotates the frame latches 116 away from an engaged position with the mold cloth frame 113a as illustrated in FIG. 9E. In this manner, the mold cloth frame 113a along with a used or expended mold cloth material 100 can be released onto the mold cloth frame support 117. As illustrated in FIGS. 9F and 9G, the wagons can then be moved laterally or indexed and the mold 64 (without a mold cloth material) raised by an exemplary overhead mechanism 66 whereby the first wagon 115a containing an expended mold cloth 100 can be indexed away from the mold 64 and a second wagon 115b containing a new mold cloth 100a in another mold cloth frame support 117 indexed under the mold 64. The mold 64 can then moved vertically and pressed into the second wagon 115b and mold cloth frame support 117 as illustrated in FIG. 9H. Once in a pressed position, the mold cloth release actuator 112 or other suitable mechanical, pneumatic or hyrdraulic mechanism can be actuated (or kept actuated) which contacts the guide device or rod 114 and can move portions of the mold cloth frame 113b, in one embodiment, or in another embodiment, rotate the frame latches 116 away from an engaged position with a mold cloth frame 113b as illustrated in FIG. 9H. As illustrated in FIG. 9I, the mold cloth release actuator 112 in placed in a non-energized or non-actuated state, whereby guide device or rod 114 can be in tension or moved vertically upward by spring, hydraulic, pneumatic force thereby engaging the mold cloth frame 113b to the mold 64, or in the embodiment shown in FIG. 9I, rotating frame latches 116 to mate and register the mold cloth frame 113b on and to the mold 64. The mold 64 can then be raised and the second wagon 115b with its empty frame support 117 indexed away from the pressing station and a glass or laminate structure 31 indexed into the pressing station or module as illustrated in FIGS. 9J and 9K.

As illustrated and described above, embodiments according to the present disclosure can provide an ability to quickly change mold cloths in a lehr having a pressing or bending module without disturbing the mold, module, wagon or lehr thermal profile and hence reducing process instabilities. Such embodiments can provide significant cost savings as in a conventional machine, the mold would require cool down to an acceptable temperature, from 700° C. down to 500° C. for example, prior to the mold cloth exchange. This cool down generally takes approximately 30 minutes to an hour. Since the tooling is still at a high temperature, exchanging mold cloth frames can take upwards of 30 minutes and the mold would require an additional heating to operating temperature, also taking another 30 minutes to an hour. Thus, embodiments described herein can save over two hours of production per each mold cloth change in an operational lehr. Furthermore, since the mold, module, wagon and lehr temperature profiles are no longer disturbed, the number of poor quality bent glass or laminate structures generated (as the cloth is no longer damaged or because the mold is not at its running temperature) can be reduced or even eliminated. In some embodiments, the cloth thickness can also be engineered to correspond to the targeted glass shape thereby reaching tighter glass tolerances without re-machining the mold.

Therefore, there is no longer a need to provide an opening in the system or lehr to access the mold and associated mechanical devices. Moreover, in embodiments having plural wagons, the motion of the wagons (or rollers) can effect a rapid mold cloth exchange resulting in less parts lost (i.e., 2) in the exchange as compared to conventional exchanges (e.g., 50 to 100). Embodiments can also be employed to tune final glass shape by introducing a cloth frame easily where the cloth or material has a non-uniform thickness intended to ‘correct’ the glass shape. Such a feature can advantageously be used to compensate any unexpected mold shape or inaccuracy linked with actual mold thermal expansion that might not be fully predictable. Thus, any unexpected shape change during, for example, an ion exchange process that was not anticipated in the initial mold design can also be adjusted at a minimal cost with this approach.

In some embodiments a bending apparatus is provided for bending a substrate, the bending apparatus having a movable shaping mold with a mold cloth disposed about portions of the movable shaping mold. An exemplary bending apparatus can include a system for replacing the mold cloth without reducing temperature in the bending apparatus. An exemplary bending apparatus can also be a lehr. In other embodiments, the system can further comprise a mold cloth frame holding the mold cloth to the shaping mold and an actuating mechanism which is configured to release or engage the mold cloth frame. Exemplary thicknesses of the substrate include up to about 2.1 mm, up to about 1.5 mm, up to about 1.0 mm, up to about 0.7 mm, or in a range of from about 0.5 mm to about 1.0 mm, or from about 0.5 mm to about 0.7 mm. An exemplary substrate can be a glass sheet or a glass laminate structure.

In other embodiments, a lehr is provided having a heating zone with a plurality of heating modules aligned and connected to each other to define a first tunnel wherein adjacent heating modules are separated from each other by a furnace door, a bending zone subsequent the heating zone with at least one bending module defining a second tunnel wherein the at least one bending module is separated from modules in adjacent zones by a furnace door, a cooling zone subsequent the bending zone and having a plurality of cooling modules aligned and connected to each other to define a third tunnel wherein adjacent bending modules are separated from each other by a furnace door, and a conveyance mechanism for carrying one or more structures in a first direction through the heating, bending and cooling modules via the first, second and third tunnels, wherein the bending module includes a movable shaping mold with a mold cloth disposed about portions of the movable shaping mold. This lehr can include a mechanism for replacing the mold cloth without opening the bending module in a direction perpendicular to the first direction. Exemplary thicknesses of the substrate include up to about 2.1 mm, up to about 1.5 mm, up to about 1.0 mm, up to about 0.7 mm, or in a range of from about 0.5 mm to about 1.0 mm, or from about 0.5 mm to about 0.7 mm. An exemplary substrate can be a glass sheet or a glass laminate structure. In some embodiments, the first, second and third tunnels can be connected end to end. In other embodiments, the modules in the heating zone can be vertically adjacent to the modules in the cooling zone and wherein the first and third tunnels are substantially parallel to each other with the one or more structures being conveyed in a first direction in the first tunnel and in a second direction in the third tunnel. In additional embodiments, the bending module can further comprise a mold cloth frame holding the mold cloth to the shaping mold and an actuating mechanism which is configured to release or engage the mold cloth frame.

In further embodiments, a lehr is provided having a heating zone with a plurality of heating modules aligned and connected to each other to define a first tunnel wherein adjacent heating modules are separated from each other by a furnace door, a bending zone subsequent the heating zone with at least one bending module defining a second tunnel wherein the at least one bending module is separated from modules in adjacent zones by a furnace door, a cooling zone subsequent the bending zone and having a plurality of cooling modules aligned and connected to each other to define a third tunnel wherein adjacent bending modules are separated from each other by a furnace door, and a conveyance mechanism for carrying one or more structures in a first direction through the heating, bending and cooling modules via the first, second and third tunnels, wherein the bending module includes a movable shaping mold with a mold cloth disposed about portions of the movable shaping mold. This lehr can include mechanisms for replacing the mold cloth without reducing temperature in the bending module. Exemplary thicknesses of the substrate include up to about 2.1 mm, up to about 1.5 mm, up to about 1.0 mm, up to about 0.7 mm, or in a range of from about 0.5 mm to about 1.0 mm, or from about 0.5 mm to about 0.7 mm. An exemplary substrate can be a glass sheet or a glass laminate structure. In some embodiments, the first, second and third tunnels can be connected end to end. In other embodiments, the modules in the heating zone can be vertically adjacent to the modules in the cooling zone and wherein the first and third tunnels are substantially parallel to each other with the one or more structures being conveyed in a first direction in the first tunnel and in a second direction in the third tunnel. In additional embodiments, the bending module can further comprise a mold cloth frame holding the mold cloth to the shaping mold and an actuating mechanism which is configured to release or engage the mold cloth frame.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

As shown by the various configurations and embodiments illustrated in the figures, various press bending mold cloth change systems and methods have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

We claim:

1. A bending apparatus comprising:
a movable shaping mold with a mold cloth disposed about portions of the movable shaping mold; and
a system for replacing the mold cloth without reducing temperature in the bending apparatus.

2. The bending apparatus of claim 1, wherein the bending apparatus is a lehr.

3. The bending apparatus of claim 1, wherein the system further comprises a mold cloth frame holding the mold cloth to the shaping mold and an actuating mechanism which is configured to release or engage the mold cloth frame.

4. The bending apparatus of claim 1, wherein the glass structure has a thickness of up to about 2.1 mm, up to about 1.5 mm, up to about 1.0 mm, up to about 0.7 mm, or in a range of from about 0.5 mm to about 1.0 mm, or from about 0.5 mm to about 0.7 mm.

5. The bending apparatus of claim 1, wherein the glass structure is selected from the group consisting of a glass sheet, multiple glass sheets in a single stack, a glass-glass laminate structure, and a glass-polymer laminate structure.

6. The bending apparatus of claim 1, wherein the mold cloth has a non-uniform thickness over a surface thereof.

7. An apparatus comprising:
a lehr having a heating zone with a plurality of heating modules aligned and connected to each other to define a first tunnel, wherein adjacent heating modules are separated from each other by a furnace door;
a bending zone subsequent the heating zone with at least one bending module defining a second tunnel wherein the at least one bending module is separated from modules in adjacent zones by a furnace door;
a cooling zone subsequent the bending zone and having a plurality of cooling modules aligned and connected to each other to define a third tunnel wherein adjacent bending modules are separated from each other by a furnace door;
a conveyance mechanism for carrying one or more structures in a first direction through the heating, bending and cooling modules via the first, second and third tunnels, wherein the bending module includes a movable shaping mold with a mold cloth disposed about portions of the movable shaping mold; and
a system for replacing the mold cloth without opening the bending module in a direction perpendicular to the first direction.

8. The apparatus of claim 7, wherein the one or more structures has a thickness of up to about 2.1 mm, up to about 1.5 mm, up to about 1.0 mm, up to about 0.7 mm, or in a range of from about 0.5 mm to about 1.0 mm, or from about 0.5 mm to about 0.7 mm.

9. The apparatus of claim 7, wherein the one or more structures is selected from the group consisting of a glass sheet, multiple glass sheets in a single stack, a glass-glass laminate structure, and a glass-polymer laminate structure.

10. The apparatus of claim 7, wherein the first, second and third tunnels are connected end to end.

11. The apparatus of claim 7, wherein the modules in the heating zone are vertically adjacent to the modules in the cooling zone and wherein the first and third tunnels are substantially parallel to each other with the one or more structures being conveyed in a first direction in the first tunnel and in a second direction in the third tunnel.

12. The apparatus of claim 7, wherein the mold cloth has a non-uniform thickness over a surface thereof.

13. The apparatus of claim 7, wherein the bending module further comprises a mold cloth frame holding the mold cloth to the shaping mold and an actuating mechanism which is configured to release or engage the mold cloth frame.

14. An apparatus comprising:
a lehr having a heating zone with a plurality of heating modules aligned and connected to each other to define a first tunnel wherein adjacent heating modules are separated from each other by a furnace door;
a bending zone subsequent the heating zone with at least one bending module defining a second tunnel wherein the at least one bending module is separated from modules in adjacent zones by a furnace door;
a cooling zone subsequent the bending zone and having a plurality of cooling modules aligned and connected to each other to define a third tunnel wherein adjacent bending modules are separated from each other by a furnace door;
a conveyance mechanism for carrying one or more structures in a first direction through the heating, bending and cooling modules via the first, second and third tunnels, wherein the bending module includes a movable shaping mold with a mold cloth disposed about portions of the movable shaping mold; and
a system for replacing the mold cloth without reducing temperature in the bending module.

15. The apparatus of claim 14, wherein the one or more structures has a thickness of up to about 2.1 mm, up to about 1.5 mm, up to about 1.0 mm, up to about 0.7 mm, or in a range of from about 0.5 mm to about 1.0 mm, or from about 0.5 mm to about 0.7 mm.

16. The apparatus of claim 14, wherein the one or more structures is selected from the group consisting of a glass sheet, multiple glass sheets in a single stack, a glass-glass laminate structure, and a glass-polymer laminate structure.

17. The apparatus of claim 14, wherein the first, second and third tunnels are connected end to end.

18. The apparatus of claim 14, wherein the modules in the heating zone are vertically adjacent to the modules in the cooling zone and wherein the first and third tunnels are substantially parallel to each other with the one or more structures being conveyed in a first direction in the first tunnel and in a second direction in the third tunnel.

19. The apparatus of claim 14, wherein the bending module further comprises a mold cloth frame holding the mold cloth to the shaping mold and an actuating mechanism which is configured to release or engage the mold cloth frame.

20. The apparatus of claim 14, wherein the mold cloth has a non-uniform thickness over a surface thereof.
